(19) United States
(12) Patent Application Publication
(10) Pub. No.: US 2017/0318007 A1
(43) Pub. Date: Nov. 2, 2017

(54) IDENTIFICATION SYSTEM AND METHOD

(71) Applicant: TOUCH NETWORKS AUSTRALIA PTY LTD, Melbourne, Victoria (AU)

(72) Inventor: Adrian Xavier Cleeve, Melbourne (AU)

(21) Appl. No.: 15/520,392

(22) PCT Filed: Oct. 29, 2015
(86) PCT No.: PCT/AU2015/000644

§ 371 Date: Apr. 19, 2017

(30) Foreign Application Priority Data
Oct. 30, 2014 (AU) 2014904361

(51) Int. Cl. H04L 29/06; G06F 17/30

(52) U.S. Cl. CPC H04L 63/083; G06F 17/30864

(57) ABSTRACT

An identification system for identifying a user accessing a website hosted by a web server with a user device comprising a user database arranged to store data of a plurality of registered users. A device identifier arranged to receive from the web server user device data indicative of user device accessing the website, the device identifier being further arranged to compare the received user device data with the device identification data entries stored in the user database to determine if the user device corresponds to registered user device and if it is a registered user device, the device identifier being arranged to identify user score from the data stored in the database associated with the identified registered user device. An indication setter arranged to indicate one status of plurality of defined statuses to user via user device accessing the website, wherein the indicated status corresponds to the user's score.

### FIELD OF THE INVENTION

The present invention is generally related to an identification system and particularly, although not exclusively, related to an identification and user identity verification system.

### BACKGROUND TO THE INVENTION

Increasingly, consumers are able to purchase a wide variety of goods and services online from a wide variety of merchants. A consumer may be required to register an online account with a merchant before making a purchase. A consumer who purchases from more than one merchant can be inconvenienced when having to open multiple accounts, each with associated login credentials.

Further, merchants can expose themselves to the potential for fraudulent transactions through these accounts.

### SUMMARY OF THE INVENTION

In a first broad aspect the invention provides an identification system for identifying a user accessing a website hosted by a web server with a user device comprising:
a user database arranged to store data of a plurality of registered users, wherein the data includes: i) device identification data for each of the plurality of users that corresponds to a registered user device used to access the website, and, for each user, at least one of ii) a score; and iii) information from which the system can derive a score for the respective user;
a device identifier arranged to receive from the web server user device data indicative of a user device accessing the website, the device identifier being further arranged to compare the received user device data with the device identification data entries stored in the user database to determine if the user device accessing the website corresponds to a registered user device and in response to determining that the user device corresponds to a registered user device, the device identifier being arranged to identify a user score from the data stored in the database associated with the identified registered user device; and
an indication setter arranged to indicate one status of a plurality of defined statuses to a user via a user device accessing the website, wherein the indicated status corresponds to the user's score.

In an embodiment, the identification system comprises a registration system arranged to register a new user with the identification system by receiving from the new user data indicative of information relating to the new user and to store that data in the user database.

In an embodiment, the registration system facilitates a user verifier arranged to verify the identity of the new user.

In an embodiment, the user verifier verifies the user's identity via a points check based on documents submitted by the new user, and wherein the user's score corresponds to the points allocated to the user.

In an embodiment, the identification system comprises a user authenticator arranged to implement multi-step authentication upon the device identifier determining that the user device accessing the website is registered to more than one user.

In an embodiment, the user authenticator is arranged to generate and transmit a token to the user device accessing the website.

In an embodiment, the indication setter is arranged to control the appearance of a cursor displayed on the user device.

In an embodiment, the identification system comprises an identification request handler arranged to receive a device identification request from a third party web server, and to transmit to the third party web server at least one of the score and information from which the system can derive a score for the respective user corresponding to the user device accessing the third party web server.

In an embodiment, in response to determining that the user device does not correspond to a registered user device, the identification system is arranged to register the user device in the user database in association with a new user or an existing user.

In a second broad aspect the invention provides an identification method for identifying a user accessing a website hosted by a web server with a user device comprising:
storing data indicative of information relating to a plurality of registered users in a user database, wherein the data includes: i) device identification data for each of the plurality of users that corresponds to a registered user device used to access the website, and ii) a score for each of the plurality of users;
receiving from the web server user device data indicative of a user device accessing the website;
comparing the received user device data with each of the device identification data entries stored in the user database;
determining if the user device accessing the website corresponds to a registered user device;
in response to determining that the user device corresponds to a registered user device, identifying a user score from the data stored in the database associated with the identified registered user device; and
indicating one status of a plurality of defined statuses to a user via a user device accessing the website, wherein the status corresponds to the user's score.

In an embodiment, the identification method comprises registering a new user by receiving from the new user data indicative of information relating to the new user, and storing that data in the user database.

In an embodiment, the identification method comprises verifying the identity of the new user.

In an embodiment, the identification method comprises verifying the user's identity via a points check based on documents submitted by the user, and wherein the user's score corresponds to the points allocated to the user.

In an embodiment, the identification method comprises implementing multi-step authentication upon determining that the user device accessing the website is registered to more than one user.

In an embodiment, the identification method comprises generating and transmitting a token to the user device accessing the website.

In an embodiment, the identification method comprises controlling the appearance of a cursor displayed on the user device.

In an embodiment, the identification method comprises receiving a device identification request from a third party web server, and transmitting to the third party web server at least one of the score and information from which the system can derive a score for the respective user corresponding to the user device accessing the third party web server.

In an embodiment, in response to determining that the user device does not correspond to a registered user device, registering the user device in the user database in association with a new user or an existing user.

In a third broad aspect the invention provides computer program code which when executed implements the method of the second broad aspect.

In a fourth broad aspect the invention provides a computer readable medium comprising the computer program code of the third broad aspect.

### BRIEF DESCRIPTION OF THE DRAWINGS

In order that the invention may be more clearly ascertained, embodiments will now be described, by way of example, with reference to the accompanying drawing, in which:

FIG. 1 is a block diagram of an identification system according to an embodiment of the invention. Also shown is a third-party web server and a user device; and

FIG. 2 is a flow chart of a method of an embodiment of the invention.

### DETAILED DESCRIPTION OF EMBODIMENTS OF THE INVENTION

The invention is generally related to an identification system arranged to implement a method of identifying a user based on a user device used to visit or access a website. The identification system provides feedback to the user to enable the user to ascertain that they have been identified. In an embodiment, the feedback includes one of a plurality of statuses so that the user can identify the status that has been allocated to them. The identification system is typically provided by an organisation (such as a company) for identifying devices or users accessing an organisation website or third-party website or both. The third party is typically an online vendor, but may be any suitable party.

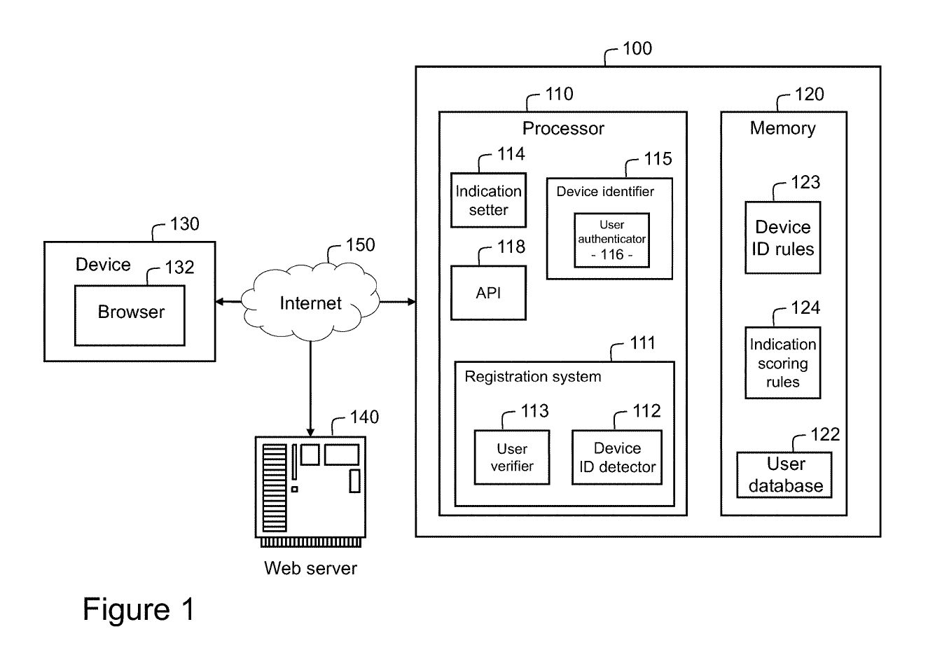

FIG. 1 illustrates an identification system 100 including a processor 110 that is arranged to implement a number of modules based on program code and data stored in memory 120. A person skilled in the art will appreciate that one or more of the modules could be implemented in some other way, for example by a dedicated circuit. The identification system 100 may be provided on a server or in any other suitable manner.

The identification method is implemented by the identification system 100 in response to a user using a user device 130 to navigate to a website or a particular part of a website, such as a sales portal, via, for example, a web browser 132. The website is typically hosted on a web server 140 and accessed via the internet 150 or any other suitable network, such as an internal intranet. The web server 140 may be owned or rented by the organisation or the third-party. The device 130 may be any suitable device that allows a user to access websites via the internet, such as a desktop or laptop computer, a tablet or a smartphone.

In this specification, an example of a user navigating to an airline website to buy an airline ticket is given. However, the identification system 100 may be applied to any other suitable application. In this example, it is assumed that the identification system 100 is owned and administrated by the organisation, and that the third-party airline company owns and administers the airline website. However, in some embodiments the identification system 100 and website may be owned and administered by the same organisation.

The identification system typically comprises a user database 122 with information relating to registered users and their corresponding user devices stored therein. A user device may, for example, belong to a user who has previously registered with the identification system 100. The identification system 100 may provide a registration system 111 or portal that facilitates a registration process for the registration of a user with the identification system 100. Alternatively, the user may register via the third-party website or in any other suitable manner.

For example, the user may wish to buy flights online via the airline website. The user, upon navigating to the website may be presented with a “register” and “login” option or screen, which may be provided and administered by the organisation via the registration system 111. A user may register with the website by selecting the “register” option and providing information, such as a password, and an email address or username. Other information may be provided or required, such as a first name, last name, residential address, billing address, payment card details (such as a credit or debit card), membership number and phone number. This information is stored in the user database 122.

A user typically registers with the identification system 100 from a personal user device 130 such as their personal laptop or desktop, tablet or smartphone. (Users may be discouraged to register with the service from public or shared devices for reasons that will become apparent below.) The identification system 100 comprises a device identification detector 112 that is arranged to detect device identification data or information corresponding to the user device being used for the registration process. The device identification information is also stored in the user database 122 in association with other data relating to a user. The device identification information may be a device's IP address, international mobile subscriber identity (IMSI) or any other suitable, identifying information.

A user may wish to later access the identification system 100 from a new device that is different to the device used to register an account. The user may navigate to the website on the new device, select the “login” option, and enter their login credentials such as a username and password. Upon a successful user login, the identification system 100 may detect the new device's identification information and compare it to existing device identification information stored in the user database 122. New device identification information may be stored in the user database 122 in addition to existing user data including the old device identification information.

The registration system 111 may include a user verifier 113 arranged to verify the identity of a user. In an embodiment, the user verifier 113 verifies a user's identity via a point check facilitated by a points system. The user verifier 113 may be provided by the organisation or by a different party, such as a bank, mobile-phone service provider or government department. In this embodiment, the points system facilitates a points check in which a user is required to submit identifying documents (such as a passport or birth certificate), where each document has an associated point value. Each user is allocated a score based on an aggregate of points from each of their furnished documents. The points system may recognise or provide several score thresholds. For example, the points system 113 may provide score thresholds of: i) 100 points, in which a user obtains gold status, indicating high confidence in the user's identity, ii) 80 points, in which a user obtains silver status, indicating medium confidence in the user's identity, and iii) 60 points, in which a user obtains bronze status, indicating low confidence in a user's identity. For example, a passport may be worth 70 points, a driver license may be worth 40 points, and a credit card may be worth 25 points. A user that submits a passport and a driver license will be allocated a score of 110 points, indicating that they are a gold-status user. A user that that submits a passport and a credit card will be allocated a score of 95 points, indicating that they are a silver-status user. This user may later furnish another document worth 5 or more points so that they become a gold-status user.

As mentioned above, in some embodiments, the user verifier 113 may be provided by a different party. For example, a user may activate a new mobile phone account with a mobile-phone service provider, such as Optus. Optus may then conduct a point check on the user by manually or automatically sighting and certifying documents provided by the user, and allocating them an associated point score. In such embodiments, the user's score is provided to the identification system 100, and is ultimately provided to a third party (such as the airline) in order to at least verify a user's identification.

The identification system 100 may be provided from the organisation to a number of third parties. Thus, a user may navigate to a number of third party websites and have his identity verified at each without having to create multiple accounts. For example, a user may register with the identification system 100 at a third party website (such as a mobile-phone service provider website) and then be able to login at a different third party website (such as an airline website) by using the same login credentials. Alternatively, a user may be automatically logged in to a website upon a website detecting an associated user device, as is discussed further below.

In some embodiments, different users may use the same device to access the third party websites. For example, a family computer may be used by several different family members to access the third party website. In such instances, each family member may be separately registered with the identification system 100. The identification system 100 may determine that two or more users correspond to the same device when they register, when they log on, or at any other suitable time. In such instances, the identification system 100 may determine which user has logged on upon the receipt of a personal identification number (PIN), one-time code or other identification token provided by the user. For example, the user information stored in the user database 122 may comprise a predetermined PIN, and the user may enter the PIN when prompted by the identification system 100, and allowed access to certain website features if the PINs match. Alternatively, the identification system 100 may be arranged to generate a one-time code that is sent to the user (for example, in an email or text message) and input by the user. However, this may be done in any suitable manner.

Thus, a user may be identified and allowed access to restricted parts of a website upon navigating to it, and optionally, upon entering an identification token. For example, a user may navigate to the airline website for the purpose of booking a flight. The airline website is able to identify the user via the identification system 100 based on the device identification information. The general public may be allowed access to flight information (such as searching functions), but the identified user may additionally be allowed access to his personal checkout, billing and shipping information. The user may select a flight and click a purchase button resulting in: i) the flight being bought using credit card and billing information previously registered during the registration process, and ii) an itinerary and receipt being emailed using an email address registered during the registration process. This may be advantageous in that it simplifies a log in and authorisation process. This may also be advantageous in that the third party has an indication of the reliability of the user's identification, which may be useful for fraud prevention.

The identification system 100 comprises a device identifier 115 arranged to identify a device that navigates to a website that uses the identification system 100. A web server may be arranged to detect when a device accesses its associated website. Using an application programming interface (API) 118 or identification request handler provided by the organisation that owns or administers the registration system 100, the web server may request device identification via the device identifier 115 upon detecting that a device has accessed its associated website. The web server may transmit data indicative of the device's identification information (such as an IP address or IMSI) to the identification system 100 or device identifier 115 for processing by the device identifier 115 according to device identification rules 123. The device identification rules 123 may implement a comparator that compares the received device identification information with each device identification information entry stored in the user database 122.

In some embodiments, the identification system 100 is arranged to distinguish between different users that use the same device, such as different members of a family. For example, if the device identifier 115 via the device identification rules 123 determines that more than one user exists for the device identification information, the user may be prompted via the website to submit further distinguishing information, such as a PIN or a one-time code. In an embodiment, the identification system 100 comprises a user authenticator 116 arranged to authenticate a particular user when the device identifier 115 determines that more than one user is registered for the identified device. For example, the user authenticator 116 may generate and send a code or other suitable token to a user via email, text message or in any other suitable manner. The user is prompted to enter the token at the website so that the identification system 100 can determine the particular user, for example, via the device identification rules 123.

The identification system 100 comprises an indication setter 117 arranged to indicate the user's status to the user upon the user navigating to the website.

For example, the indication setter 117 may control a cursor to be displayed on the screen of a gold-status user's device as a gold man icon. Similarly, the indication setter 117 may control a cursor to be displayed on the screen of a silver- or bronze-status user's device as a silver or bronze man icon, respectively. This may indicate the user's status to the user and, in cases where a lower-than-desired status is displayed, may prompt the user to upgrade their status, for example, by submitting documents for points. However, a user's status may be indicated to a user in any suitable manner, including audibly, visually, haptically (e.g. in mobile devices), or in any suitable combination thereof. A mobile device such as a smartphone may not display a cursor and so a coloured border or background may be used to indicate a user's status, though this may be executed in any suitable manner.

During processing of the status indication, the indication setter 114 determines the user's status based on indication scoring rules 124 stored in memory 120. In an embodiment, the indication scoring rules 124 comprise instructions to determine a user's status based on the user's score and a number of thresholds, such as 60, 80 and 100 points. A user's cursor may be controlled to be: i) gold if the user has 100 points or more, ii) silver if the user has between 80 and 99 points, iii) bronze if the user has between 60 and 79 points, or iv) blue if the use has less than 60 points.

In an embodiment, different scoring rules may be applied for different third-party websites such that different statuses may be assigned to a single user. For example, scoring rules for a first website may allocate 10 points to a copy of correspondence with the user's name and address on it, while other systems may not accept correspondence as the basis for allocation of points.

In an embodiment, the device identifier 115 may be arranged to determine if a device accessing the website is not registered with the identification system 100. In such instances, the indication setter 114 may indicate to the user that the device or the user is not registered in any suitable manner, such as by displaying a red cursor or a pop-up box. Upon such a determination, the user may be presented with the option to register with the system. This may be advantageous in that it markets the system with a view to expanding its user base. The user may also be presented with an option to indicate that they are indeed registered with the identification system 100, which may indicate that they are accessing the website from a previously-unregistered device, such as a new phone or a work computer. The user may enter login credentials in any suitable manner in order to register this new device with the registration system. Such credentials may include a username and password. In addition, the user authenticator 116 may provide a token for multi-step authentication, such as two-step authentication.

The registration system 100 may provide an API 118 so that third party website interaction with the registration system 100 can be customised. For example, an airline may wish to offer bonuses, rewards or incentives to users who are registered with the registration system 100, which may build customer loyalty and may reduce administration overhead time because a user's transaction details are known.

The information (such as that stored in the user database 122) collected by the identification system 100 may be valuable to the owner of the identification system 100 because access (such as through APIs) could be sold to third parties so that third party customers registered with the system 100 have a convenient manner in which to confirm their identity to, for example, make online purchases.

Third-party websites may use the information to indicate to control the user's experience, for example, a gold status may indicate to the user that no further identification information will be needed for the user to make a purchase while a silver status may indicate that the user will need to answer a security question for the website.

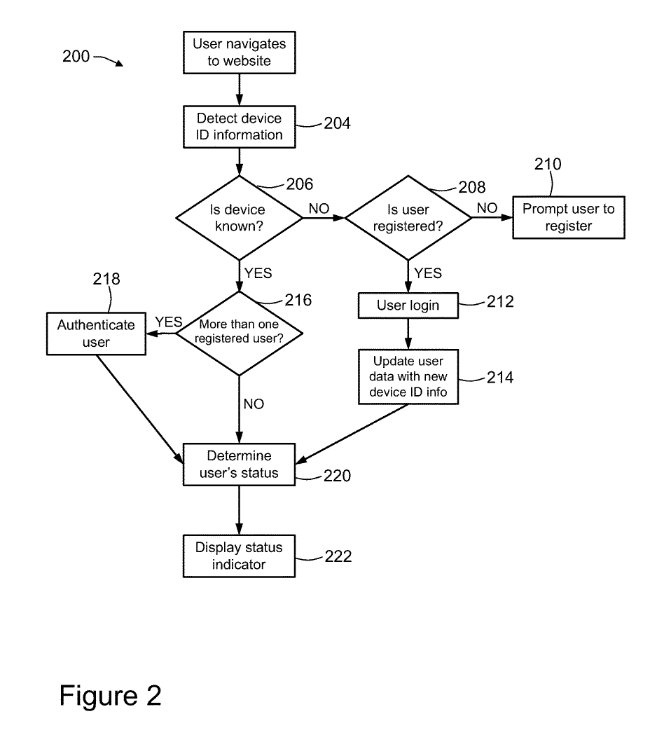

FIG. 2 illustrates a method of an embodiment of the invention. In the method 200 a user navigates 202 to a website that is supported by the registration system, such as a third-party website that may, for example, sell airline tickets. The registration system detects 204 the device identification information, which may be, for example, an IP address or any other suitable information.

The identification system determines if the detected device is known 206 in the user database. If the detected device is not known, the identification system may interrogate 208 the user (for example, by displaying a pop-up window) to determine if the user is registered, which may be the case if the user happens to be using, for example, a new device. If the user indicates that he is not registered, the identification system may prompt the user to register 210 with the system, thereby gaining another user and associated information.

However, if at step 208 the user indicates that he is registered with the identification system, the user may be prompted to login 212, for example, by providing a username and password. The user authenticator may authenticate the user by providing a token to the user for multi-factor authentication or in any other suitable manner. The identification system may then update 214 the user data by storing the new device identification information in the user database corresponding with the user.

If at step 206 the device is known, the identification system determines 216 whether more than one registered user is registered for using that known device. If more than one user is determined, the user may be authenticated 218 by the user authenticator so that the particular user can be identified.

Upon successfully determining a device and a user, the identification system determines 220 the user's status, for example, based on the user's score and the score thresholds. The successful determination of a user and device may comprise determining: i) a known device with only one associated registered user, ii) a known device with an authenticated user, or iii) an unknown device that becomes authenticated. Finally, upon determining the user's status, the identification system controls the device to update or display an indicator that is indicative of the user's status.

The identification system may be advantageous in that it can facilitate payment between the user and the third party. The organisation that owns or administers the identification system may earn a commission from or cut of each transaction.

Persons skilled in the art will appreciate that in accordance with known techniques, functionality at the server side of the network may be distributed over a plurality of different computers, for example for load balancing or security.

Further aspects of the method will be apparent from the above description of the system. It will be appreciated that at least part of the method will be implemented electronically, for example, digitally by a processor executing program code. In this respect, in the above description certain steps are described as being carried out by the system, it will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art will appreciate that program code provides a series of instructions executable by a processor.

Herein the term “processor” is used to refer generically to any device that can process instructions and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

The various modules referred to above (such as the “indication setter” and “API”) are typically implemented using software but alternatively may be implemented using hardware or a combination of software and hardware. The modules may be implemented using any suitable computer program code or any suitable programming language. The computer program code is typically stored on a computer readable medium such a hard disk drive (HDD) or random access memory (RAM).

It will be understood to persons skilled in the art of the invention that many modifications may be made without departing from the spirit and scope of the invention.

In the claims that follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that such prior art forms a part of the common general knowledge in the art, in Australia or any other country.

1. An identification system for identifying a user accessing a website hosted by a web server with a user device comprising:
a user database arranged to store data of a plurality of registered users, wherein the data includes: i) device identification data for each of the plurality of users that corresponds to a registered user device used to access the website, and, for each user, at least one of ii) a score; and iii) information from which the system can derive a score for the respective user;
a device identifier arranged to receive from the web server user device data indicative of a user device accessing the website, the device identifier being further arranged to compare the received user device data with the device identification data entries stored in the user database to determine if the user device accessing the website corresponds to a registered user device and in response to determining that the user device corresponds to a registered user device, the device identifier being arranged to identify a user score from the data stored in the database associated with the identified registered user device; and
an indication setter arranged to indicate one status of a plurality of defined statuses to a user via a user device accessing the website, wherein the indicated status is determined in accordance with the user score identified by the device identifier.

2. An identification system as claimed in claim 1, comprising a registration system arranged to register a new user with the identification system by receiving from the new user data indicative of information relating to the new user and to store that data in the user database.

3. An identification system as claimed in claim 2, wherein the registration system facilitates a user verifier arranged to verify the identity of the new user.

4. An identification system as claimed in claim 3, wherein the user verifier verifies the user's identity via a points check based on documents submitted by the new user, and wherein the user's score corresponds to the points allocated to the user.

5. An identification system as claimed in claim 1, comprising a user authenticator arranged to implement multi-step authentication upon the device identifier determining that the user device accessing the website is registered to more than one user.

6. An identification system as claimed in claim 5, wherein the user authenticator is arranged to generate and transmit a token to the user device accessing the web site.

7. An identification system as claimed in claim 1, wherein the indication setter is arranged to control the appearance of a cursor displayed on the user device.

8. An identification system as claimed in claim 1, comprising an identification request handler arranged to receive a device identification request from a third party web server, and to transmit to the third party web server at least one of the score and information from which the system can derive a score for the respective user corresponding to the user device accessing the third party web server.

9. An identification system as claimed in claim 1, wherein in response to determining that the user device does not correspond to a registered user device, the identification system is arranged to register the user device in the user database in association with a new user or an existing user.

10. An identification method for identifying a user accessing a website hosted by a web server with a user device comprising:
storing data indicative of information relating to a plurality of registered users in a user database, wherein the data includes: i) device identification data for each of the plurality of users that corresponds to a registered user device used to access the website, and ii) a score for each of the plurality of users;
receiving from the web server user device data indicative of a user device accessing the website;
comparing the received user device data with the device identification data entries stored in the user database;
determining if the user device accessing the website corresponds to a registered user device;
in response to determining that the user device corresponds to a registered user device, identifying a user score from the data stored in the database associated with the identified registered user device; and
indicating one status of a plurality of defined statuses to a user via a user device accessing the website, wherein the status is determined in accordance with the identified user score.

11. An identification method as claimed in claim 10, comprising registering a new user by receiving from the new user data indicative of information relating to the new user, and storing that data in the user database.

12. An identification method as claimed in claim 11, comprising verifying the identity of the new user.

13. An identification method as claimed in claim 12, comprising verifying the user's identity via a points check based on documents submitted by the user, and wherein the user's score corresponds to the points allocated to the user.

14. An identification method as claimed in claim 10, comprising implementing multi-step authentication upon determining that the user device accessing the website is registered to more than one user.

15. An identification method as claimed in claim 14, comprising generating and transmitting a token to the user device accessing the website.

16. An identification method as claimed in claim 10, comprising controlling the appearance of a cursor displayed on the user device.

17. An identification method as claimed in claim 10 comprising receiving a device identification request from a third party web server, and transmitting to the third party web server at least one of the score and information from which the system can derive a score for the respective user corresponding to the user device accessing the third party web server.

18. An identification method as claimed in claim 10, comprising, in response to determining that the user device does not correspond to a registered user device, registering the user device in the user database in association with a new user or an existing user.

19. Computer program code which when executed implements the method comprising:
storing data indicative of information relating to a plurality of registered users in a user database, wherein the data includes: i) device identification data for each of the plurality of users that corresponds to a registered user device used to access the website, and ii) a score for each of the plurality of users;
receiving from the web server user device data indicative of a user device accessing the website;
comparing the received user device data with the device identification data entries stored in the user database;
determining if the user device accessing the website corresponds to a registered user device;
in response to determining that the user device corresponds to a registered user device, identifying a user score from the data stored in the database associated with the identified registered user device; and
indicating one status of a plurality of defined statuses to a user via a user device accessing the website, wherein the status is determined in accordance with the identified user score.

20. A tangible computer readable medium comprising a computer program code that, when executed, causes a processor to:
store data indicative of information relating to a plurality of registered users in a user database, wherein the data includes: i) device identification data for each of the plurality of users that corresponds to a registered user device used to access the website, and ii) a score for each of the plurality of users;
receive from the web server user device data indicative of a user device accessing the website;
compare the received user device data with the device identification data entries stored in the user database;
determine if the user device accessing the website corresponds to a registered user device;
in response to determining that the user device corresponds to a registered user device, identify a user score from the data stored in the database associated with the identified registered user device; and
indicate one status of a plurality of defined statuses to a user via a user device accessing the website, wherein the status is determined in accordance with the identified user score.
